(19) United States
(12) Patent Application Publication
(10) Pub. No.: US 2002/0179400 A1
(43) Pub. Date: Dec. 5, 2002

(54) Spiral conveyor

(76) Inventors: Robert Edward Dersham, Palm Harbor, FL (US); Harold Eugene Noble, Wilmington, DE (US)

Correspondence Address: Cohen & Grigsby, P.C., 15th Floor, 11 Stanwix Street, Pittsburgh, PA, 15222, US

(21) Appl. No.: 10/073,526

(22) Filed: Feb. 11, 2002

Related U.S. Application Data
(60) Provisional application No. 60/267,582, filed on Feb. 9, 2001.

(51) Int. Cl. B65G 13/02

(52) U.S. Cl. 193/1

(57) ABSTRACT

A spiral conveyor comprising a support frame mounted on a base, a plurality of arcuate conveyor sections interconnected to form a helical conveyor having at least one entrance and one discharge, each of said conveyor sections having a plurality of self-driven conveyor rollers, each of said rollers being activated to rotate in clockwise or counterclockwise direction at a selectable speed, sensor means positioned on selected conveyor sections for detecting the presence of a load in such section, and control logic means for operating said rollers in either an upward or a downward direction.

### FIELD OF THE INVENTION

The present invention relates to a spiral conveyor system, and, in particular to a spiral conveyor system that is not dependent upon gravity that can convey both up and down and provide accumulation capability.

### BACKGROUND OF THE INVENTION

Spiral conveyors have been known and used for many years, e.g. U.S. Pat. No. 790,776. These conveyors are especially useful in conveying items from an upper to a lower level with a minimum of floor space being required. Many devices have been incorporated into such conveyors to impede the speed of conveyed articles including brakes on conveyor rollers, path constrictors, and other such devices. In addition it has been known to space the load for accumulation. Because the loads on such conveyors move by gravity flow, it is desirable to prevent the entire load positioned along the run of the conveyor from bearing against each other to facilitate removal at the discharge end and to minimize breakage. Accordingly, load spacing devices have been used to properly space the leading load at the discharge end of the conveyor from the remaining run of loads behind the lead load. See, e.g. U.S. Pat. No. 3,532,201

In recent years, spiral conveyors have been made available using electronic sensing means for accumulation and control of loads being gravity fed. See, e.g. U.S. Pat. No. 5,901,827 wherein electronic sensing means are used in combination of powered rollers which are reversed to impede the downward travel of selected loadings on the conveyor for staging loads on conveyor at preselected zones. Other advances have been made to such conveyors which enables control of the downward flow through the system by programming and sorting means. However, a degree of control in state of the art conveyors does not provide that needed in high speed shipping and sorting applications nor do state of the art systems provide for the upward flow of conveyed loads.

Accordingly it is an object of the present invention to provide a spiral conveyor system that is not gravity dependent. Another object of the invention is to provide a spiral conveyor system that can convey both in a downward or upward direction to facilitate various sorting and shipping configurations. A yet further object of the invention is to provide a conveyor having a very small foot print to save floor space and provide high speed logic controlled flows.

### SUMMARY OF THE INVENTION

Generally, the present invention comprises a spiral conveyor having a small foot print with powered conveyor rolls which permit the downward and upward flow of loadings. In a presently preferred embodiment of the invention, the spiral conveyor is particularly well suited to conveying trays of product such as part of mail pieces. In the preferred embodiment of the invention all of the conveyor rolls are motorized to permit full controllability of the movement of trays up and down the conveyor. By such control it is possible to accurately control the spacing of the loads on the conveyor so that there is no touching of the trays during transport.

Zones are preferably established along the length of the conveyor in which loads are accumulated or parked during conveyance. In a preferred embodiment, the zones comprise 90° arcuate sections. Depending on the height of the conveyor, multiple sections are used to control and accumulate the flow of product. In each zone at least one sensor is included to sense the existence of a product. Also multiple sensors can be used in a zone to determine the number of products that have been accumulated therein. By adjusting the forward or backward direction of the rollers or their speed, the product can be controllably spaced. In addition, the speed of each product can be accurately controlled using multiple sensors which is useful when products contain various amounts of product or of different types of loads. Further refinement of the system of the present invention is accomplished through the use of additional informational detection means such as bar coding scanners or RFID detectors to obtain precise information for logging and position control of labeled product.

By means of the controllable rollers, zoned sensing and programmed logic, the spiral conveyor of the present invention provides a conveyor system that can be run automatically. Other advantages of the invention will become apparent from a perusal of the following detailed description of presently preferred embodiment of the invention taken in connection with the accompanying drawings.

### BRIEF DESCRIPTION OF THE DRAWINGS

FIG. 1 is an elevation of a presently preferred embodiment of an up and down flow spiral conveyor of the present invention;

FIG. 2 is a plan view of the spiral conveyor shown in FIG. 1;

FIG. 3 is plan view of an arcuate section or zone of the spiral conveyor shown in FIG. 1;

FIG. 4 is cross sectional elevation taken along line A-A of FIG. 3;

FIGS. 5 and 6 are a flow diagram of the down flow logic for controlling the conveyor shown in FIG. 1; and

FIGS. 7 and 8 are a flow diagram of the up flow logic for controlling the conveyor shown in FIG. 1.

### PRESENTLY PREFERRED EMBODIMENTS

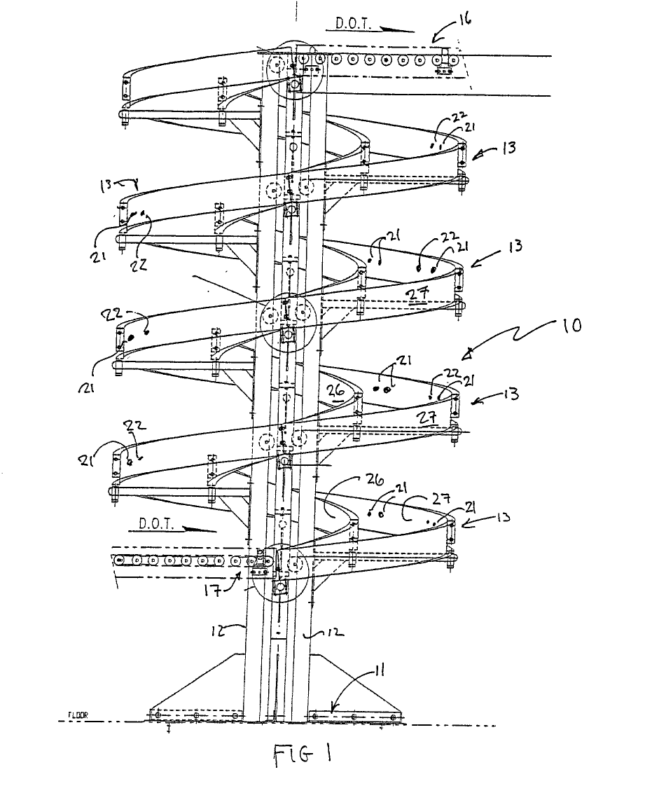

Referring to FIG. 1, conveyor 10 of the present invention comprises a base 11 and a support frame 12 which supports a plurality of arcuate conveyor sections 13. Conveyor 10 has discharge/entry port 16 at its upper end and entry/discharge end 17 at its lower end. In the preferred embodiment each arcuate section 13 comprises a zone of 90° which includes at least one sensor means 21, such as a photocell or other electrical or mechanical means. Sensors 21 are positioned at either the entrance or exit to a zone and preferably at both the entrance and exit of zone in an up/down conveyor such as conveyor 10. In some applications, multiple sensors 21 are positioned along inner and outer frames of the arcuate sections 13 and spaced apart in relationship to the size of the trays to be conveyed. Additionally, sensors 22 may optionally be positioned in conjunction with or in lieu of sensors 21 to provide data information for accurate logging and control. Sensors 22 may comprise bar code scanners, radio frequency identification detectors or laser image readers, for example. These scanners permit the collection of data concerning the location of each labeled loads as it passes through each section or zone.

Arcuate sections of a preferred embodiment have an inner radii of from 14 inches up to 48 inches. Larger radii sections can also be used, but the footprint of the conveyor becomes larger. In a preferred embodiment a helix pitch of from 5° to 6° is desirable. However, a pitch of 25° can be accommodated by motorized rollers. This pitch may be increased by using high torque motor rollers coupled with a high coefficient of friction covering on the rollers. The outer radii of the section is variable to accommodate the size of the loads or products for which conveyor 10 is designed to transport.

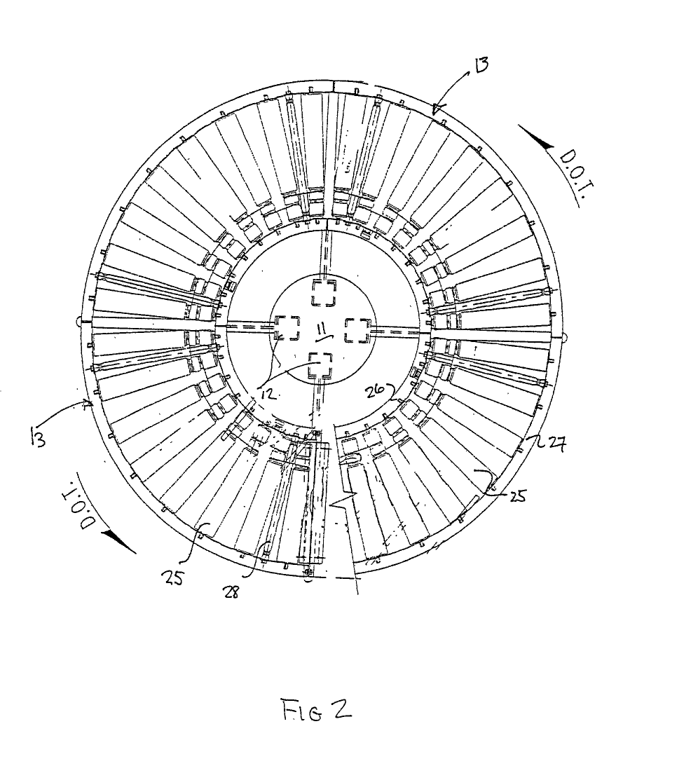

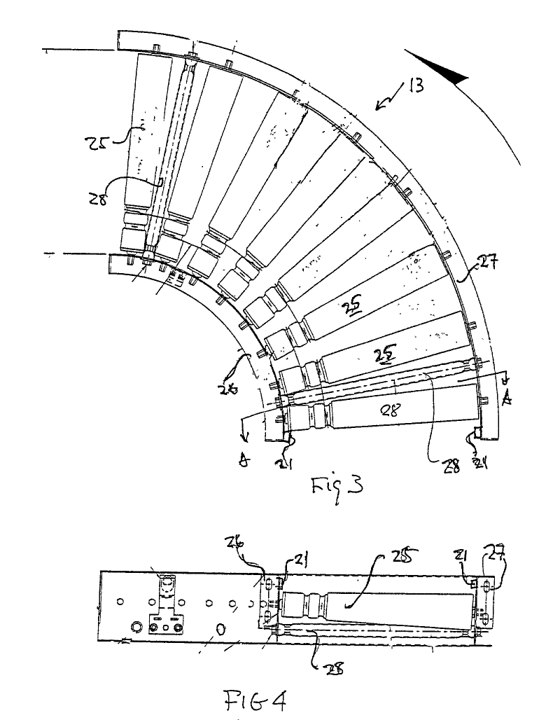

Referring to FIGS. 2 through 4, each arcuate section 13 includes a plurality of motorized rollers 25. Rollers 25 are mounted between inner and outer frames 26 and 27, respectively. Inner and outer frames 26 and 27 include therebetween cross members 28 to space and retain the alignment of the frames.

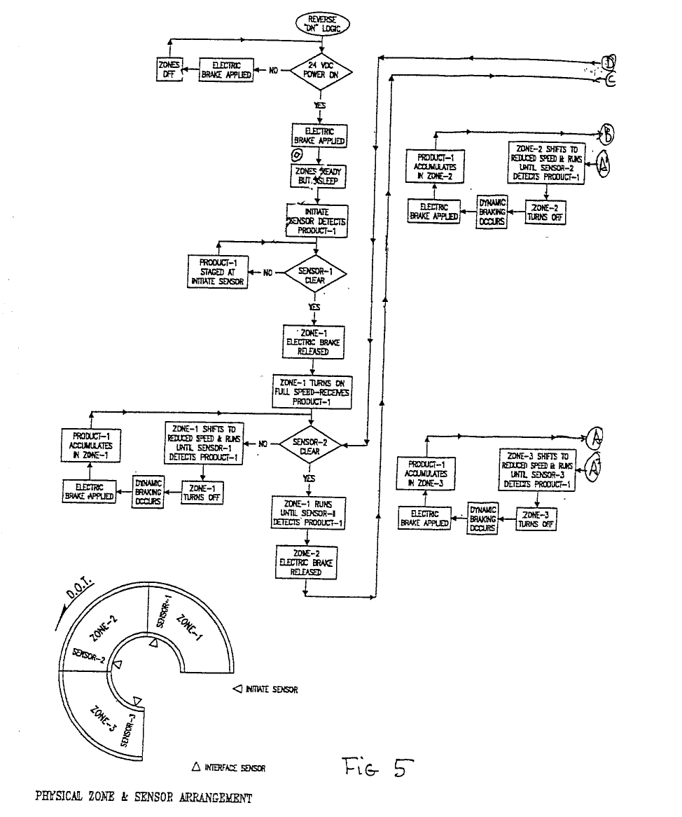

As can be seen from FIG. 4, drive rollers 25 are trapezoidal in shape to provide a constant velocity surface. The angle of the surface are calculated in a well known manner based upon the radius of the arcuate sections 13. Motorized rollers 25 are capable of powered rotation in both directions and variable speeds. Speeds may be discretely reselectable or continuous, however continuously variable speeds adds additional complexity into a system design, but increases controllability. Because of the potentially large helix pitch, it is desirable that motorized roller 25 include a covering to provide a friction surface to prevent the products from sliding over the outer surface of the rollers. Many materials have been used for this purpose in the prior art. In the preferred embodiment of conveyor 10, rollers 25 are preset to use a reduced rotational speed on the downward transport mode to function as a braking means. Typically, the reduced speed is not useful in the upward drive function.

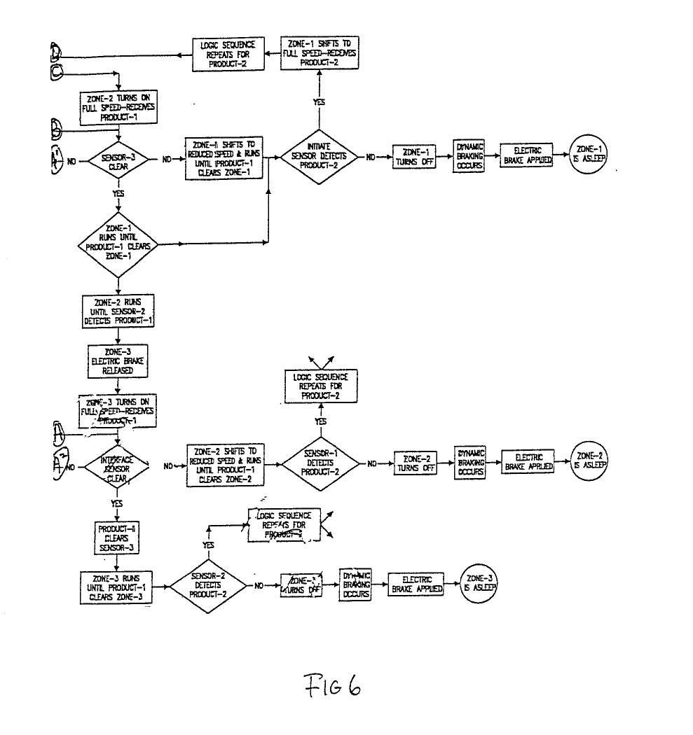

The logic controllers; not shown, are electrically connected to sensors 21 and any sensors 22 to receive signals from the respective locations along frames 26 and 26 of the zones defined by associated arcuate sections 13. The logic controllers are also connected to the motorized rollers to provide control signals for their operation control. The logic controllers comprise PLC ladder logic or may be a programmable digital computer. The PLC controllers can be programmed in a manner known to those skilled in the art to execute the control set forth in flow charts described in FIGS. 5-8.

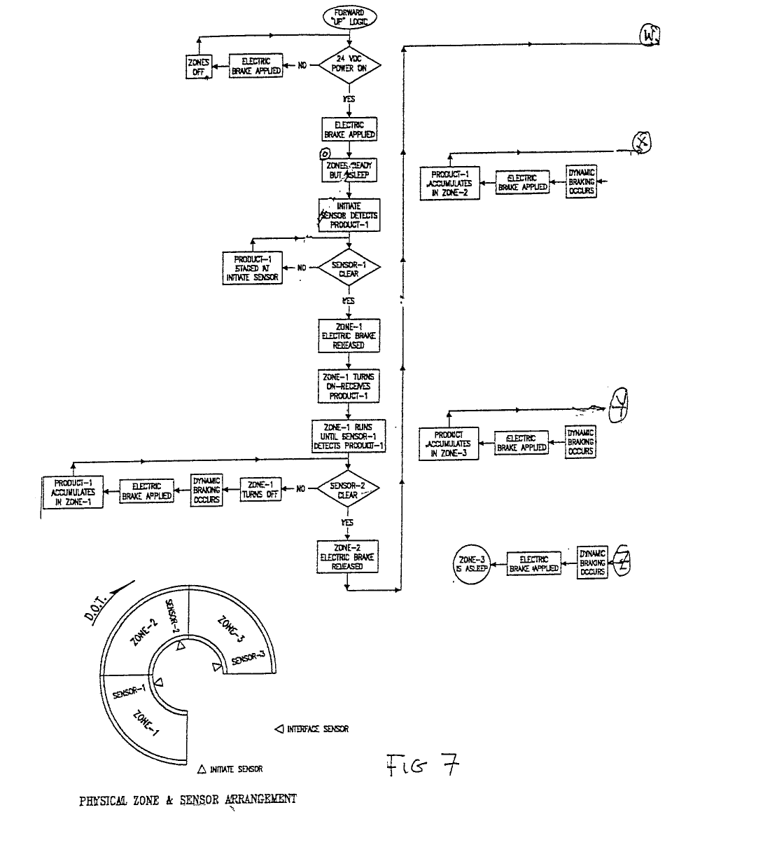

Referring to FIGS. 5 and 6, a flow diagram is represented for conveyor 10 having at least two zones. The flow diagram is equally applicable to PLC controller or programmable computers such as a personal computer or enterprise system. FIGS. 5 and 6 depict a typical logic flow for the downward travel on spiral conveyor 10. Also included on FIG. 5 is zone/sensor depiction to assist in understanding the flow diagram.

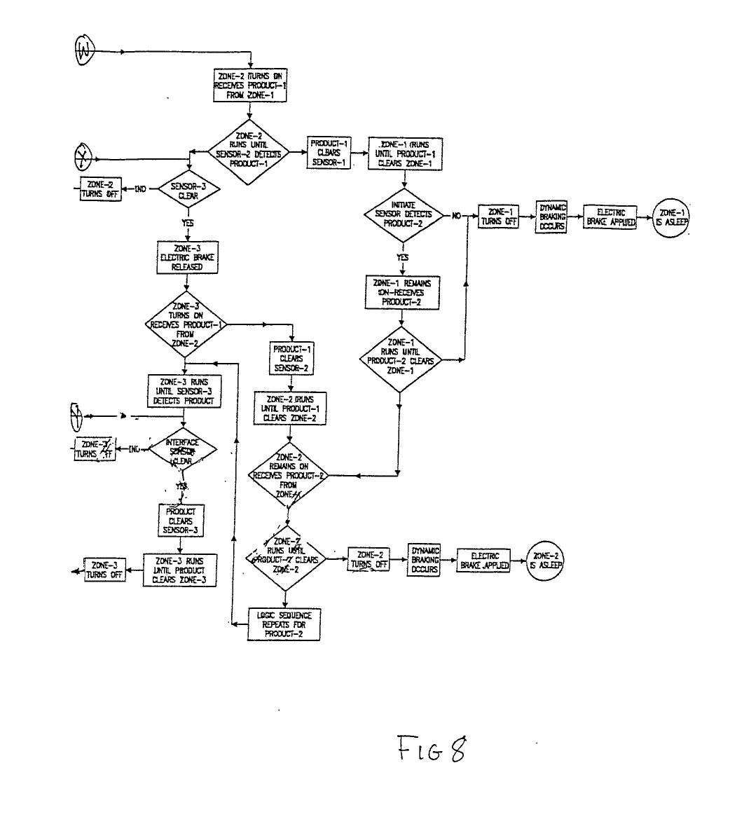

Referring to FIGS. 7 and 8 a flow diagram is represented for conveyor 10 in which the direction of travel (D.O.T.) is in the upward direction. As can be seen from these flow depictions of the logic, the up and down controls are somewhat different. It should be clear to those skilled in the art, that other sequencing of the logic can be achieved. Also, the addition of other sensors 22, such as bar code, can be included in the control logic as well as part of a data collection system.

While presently preferred embodiments of the invention have been shown and described in particularity, the invention may be otherwise embodied within the scope of the appended claims.

What is claimed is:

1. A spiral conveyor comprising a support frame mounted on a base, a plurality of arcuate conveyor sections interconnected to form a helical conveyor having at least one entrance and one discharge, each of said conveyor sections having a plurality of self-driven conveyor rollers, each of said rollers being activated to rotate in clockwise or counterclockwise direction at a selectable speed, sensor means positioned on selected conveyor sections for detecting the presence of a load in such section, and control logic means for operating said rollers in either an upward or a downward direction.

2. A spiral conveyor as set forth in claim 1 wherein said control logic means separately operates each of the rollers in each of said arcuate sections for the purpose controlling transportation through the associated arcuate section or accumulation of a load therein.

3. A spiral conveyor as set forth in claim 1 wherein selected arcuate sections include a plurality of load sensing means.

4. A spiral conveyor as set forth in claim 1 wherein the selectable speed is continuously variable.
